(19) United States
(12) Patent Application Publication
(10) Pub. No.: US 2003/0193577 A1
(43) Pub. Date: Oct. 16, 2003

(54) Multiple video camera surveillance system

(76) Inventors: Jorg Doring, Herdecke (DE); Hartmut Sprave, Alsbach-Hahnlein (DE)

Correspondence Address: NIXON & VANDERHYE, PC, 1100 N GLEBE ROAD, 8TH FLOOR, ARLINGTON, VA, 22201-4714, US

(21) Appl. No.: 10/371,192

(22) Filed: Feb. 24, 2003

(30) Foreign Application Priority Data
Mar. 7, 2002 (EP) 02 005 213.0

(51) Int. Cl. H04N 5/232

(52) U.S. Cl. 348/211.99

(57) ABSTRACT

A video surveillance system comprises a plurality of video cameras (C1, C2, . . . , Ci) as well as a video signal switch (MUX), a means (SC) for controlling the video signal switch (MUX) and the video cameras (C1, C2, . . . , Ci) and a video signal recording means (VR). The video cameras (C1, C2, . . . , Ci) each comprise a pulse generating means (TC) for free-running generation of a sequence of horizontal and vertical synchronization pulses, and a means (SP) for combining the image and the sequence of horizontal and vertical synchronization pulses into a composite video signal. The pulse generating means (TC) assumes a predefined starting status on receiving an external reset pulse (R) and generates the sequence of the horizontal and vertical synchronization pulses commencing with the predefined starting status. The system controller (SC) comprises a clock generator (CLK, FD1, FD2) for generating a reset pulse for communicating it to the video cameras (C1, C2, . . . , Ci) in common. A video signal decoding circuit in the video signal recording means (VR) locks on to the horizontal synchronization pulses contained in the video signal so quickly that it is able to decode video signals comprising time distortions caused by the periods of the sequences generated by each camera deviating from the nominal period.

The present invention relates to a multiple video camera surveillance system.

As a rule, such a surveillance system comprises a plurality of cameras, a means for switching or multiplexing the signals of each camera, and a recorder for recording the multiplexed video signals of the cameras. on a storage medium, for example, a magnetic tape or hard disk.

The element central to these systems is the multiplexer. It is this that first makes it possible to record the video signals of the individual cameras by a common recorder in time-multiplex. Multiplexing is a term designating a means which ensures that each camera connected can communicate with the recorder for a defined time interval so that the images of a plurality of cameras can be recorded alternately in sequence each with a reduced frame rate. To make available a plurality of channels for recording and playing back the images from the cameras, the multiplexer thus has the function of a switcher for switching from one camera to the next. In multiplexing video signals into a useful multiplexed signal, one needs to realize that the video signals furnished by the individual cameras comprise a relative complex format including, in addition to the actual image data, also synchronization data, as well as, where color signals are involved, so-called bursts for regenerating the color subcarrier.

To satisfy this multiplex function it is conceivable that the multiplexer first digitizes the video signals of the cameras and stores them in special field or frame memories. The multiplexer then reads these memories one after the other to generate a formatted multiplexed video output signal containing the continually changing images of the cameras (up to a frame repetition frequency of 25 Hz in Europe, 30 Hz in the USA or even up to the field frequency, i.e. 50 Hz and 60 Hz respectively). This signal is then played to the recorder. Each camera receives in a non-visible portion of the signal a special code for use in later playing back from the recorder in demultiplexing the images of the individual cameras. The demultiplexer recognizes the camera codes in the playback signal of the recorder and is able to sort but the images originating from the various cameras to restore a plurality of demultiplexed video signals.

Such a demultiplexed video signal then shows the image of a single camera at a reduced frame rate, since the connected cameras need to divide the frame rate (25 Hz in Europe, 30 Hz in the USA) of the recorded video signal.

Such a system including a digital multiplexer is of advantage in that by making use of image memories no particular demands need to be made on synchronizing the video signals of the cameras. On the other hand, such a multiplexer is expensive since it consists of a plurality of function elements, i.e. each video signal of each camera needs to be decoded, digitized, provided with the camera identification code and written into each frame memory, and then the memories need to be read out, the resulting data pieced together and coded into a new analog video signal suitable for being recorded by a video recorder. Playing back the data by the recorder is a repeat of the process in reverse.

Doing away with such a digital multiplexer would restrict the switching speed of the individual camera signals because they are not synchronized. Should the first camera happen to be at the start of an image, the next is perhaps already at the end and the third in the middle, and so on. It takes some time until the signal of the next camera can be “captured”. The time needed for this in producing synchronization involves disruptions in the picture as known in TV systems when switching from one channel to another where this evidently takes up a perceivable fraction of a second. Such a capture time is unacceptable for a system recording the frames of several cameras multiplexed.

Known from JP 62281682 A is a surveillance system serving to switch a plurality of cameras one after the other to a monitor for a direct display of the video signals of each camera for approximately 60 s, before switching to the next camera. In this arrangement, the cameras are synchronized by means of a vertical reset pulse from a synchronization signal generator so that the vertical reset pulse is generated for all cameras at the moment of switching to the next camera. This reduces the capture time for the monitor, but the signal output by the switch is not suitable for recording on a usual video recorder. Namely, at the moment in which the switching action occurs, shifts or distortions in time occur between the signal of the camera hitherto and the signal of the following camera synchronized by the vertical reset pulse due to the inertia of the rotating video head and tape transport system not being synchronized quickly enough. In other words, a recording would suffer considerable disruptions at the moment when switching is done. When the cameras are multiplexed with higher switching frequencies, for example at the frame frequency, this would result in the disruptions being correspondingly increased, making the resulting picture totally useless.

To prevent such disruptions it is conceivable to fully synchronize all of the cameras. This requires feeding a synchronization signal to each and every camera. Known from U.S. Pat. No. 5,995,140 is a system in which each camera is synchronized by means of horizontal and vertical synchronization signals. Thus, a simple analog switcher suffices as the multiplexer for switching at the frame repetition frequency. However, the solution known from this disclosure fails to be adequate for communicating and multiplexing color signals since the horizontal and vertical synchronization pulses fail to permit directly producing a color carrier synchronized to all cameras without further measures. To synchronize also the color carrier of all cameras, use can be made for the synchronization signal of a standard color video signal, for example in accordance with the PAL or NTSC standard, which contains only black image data (black burst signal). Each camera decodes the signal, extracts the synchronization signals as well as the color subcarrier and uses these signals to compose a new signal with the new picture content. This signal is then coded and output.

However, this fully synchronized solution has likewise drawbacks. The cameras become very expensive because of the synchronization portion included and the cabling needs to be extended by at least one further high-quality video cable for the relative wideband synchronization signals per camera. On top of this, a sophisticated black burst generator is needed to generate the black video signal.

Accordingly, the objective of the present invention is to define a multiple video camera surveillance system which with a modest circuit outlay is capable cost effectively of recording the signals of a plurality of video cameras multiplexed.

The present invention is defined in the claims, the sub-claims of which relate to advantageous aspects of the present invention.

The system in accordance with the invention works with a simple switcher as the multiplexer. For synchronizing the video cameras in one preferred example embodiment, use is made of the fact that video cameras can be based on semiconductor technology. Light-sensitive storage devices (CCD image converters, capacitors, transistors, or the like) are exposed for a short time (exposure time) to the light incident in the objective lens and then read out pixel by pixel. This image data is then coded and output. Controlling the timing is handled by a timing generator, usually in the form of one or more highly-integrated circuits (ICs) which digitally generate both the horizontal and vertical timing signals for driving the image converter as well as for generating the formatized video signals with horizontal and vertical pulses and where color video cameras are concerned where necessary, also with the bursts for regenerating the color subcarrier at the receiving end.

Such a digital, preferably crystal-controlled, camera circuit can be reset by means of an external signal into a well-defined starting status. Resetting all cameras simultaneously results in an initial parallel running of the cameras, since all cameras can commence simultaneously with the procedure of exposure, coding etc. Preference is given to a single reset line leading to each camera for synchronizing the cameras. The signals of the individual cameras separate from each other only gradually in time. Preferably, the cameras are reset with a frequency corresponding approximately to the period of the video signal format used or an integer number multiple thereof so that a new reset pulse is generated every time a video signal period is more or less complete. A PAL signal has a period of 8 fields corresponding to 1/(6.25 Hz) or four frame periods, whereas an NTSC signal has a period of 4 fields, corresponding to 2/(30 Hz) or two frame periods. However, even for cameras generating video signals in accordance with the PAL format, a reset frequency of a frame period or an integer number multiple thereof would be suitable.

The structure of a standardized video signal is highly complex and necessitates in general a high timing accuracy. With color signals it is particularly the phasing of the color subcarrier that is usually critical so that a receiver circuit (PLL) is able to recognize it and can regenerate the color subcarrier. In accordance with the invention, however, use is made in the cameras of usual clock oscillators, for example quartz crystal oscillators, which are not subject to requirements of the frequency accuracy and stability thereof more stringent than usual. For example, commercially available quartz crystals have a tolerance of 20 ppm (=parts per million). In a PAL system 20 ppm would result in a deviation of approximately 0.5% of the line duration per field and burst phase deviations of up to several periods of the color subcarrier frequency; although, of course, other tolerances, for example 50 ppm or also 10 ppm are likewise applicable for a video surveillance system in accordance with the invention.

In another embodiment of the invention, a recorder for the video signal available at the output of the multiplexer is provided, including a video signal decoder which is set more tolerant to time displacements or steps in the signal to be recorded than is usual in the PAL or NTSC system. This enhanced tolerance is achievable, for example, by increasing the filter bandwidth in the PLL provided for extracting the horizontal synchronization, or simply by making use of a signal window defined in time of the preferred digital PLL for locking on to the signal which is preferably not longer than the duration of the field synchronization pulse sequence, also termed black rate between the individual fields. By enhancing the tolerance to timing displacements beyond those of the video signal standard, the usual accuracy of the quartz crystals used in the cameras is then sufficient for a video signal period or even a multiple thereof before the deviations become too large to be properly decoded from the input circuit of the video signal recorder.

In accordance with a preferred embodiment, each of the cameras furnishes color video signals, for example, in accordance with the PAL or NTSC standard. Regenerating the color subcarrier from the multiplexed video signal is preferably done by fast lock-on in a video signal decoder in the recorder, only a limited time context being used from the multiplexed video signal for regenerating the color subcarrier. This time context is preferably not longer than the number of lines between two fields comprising no burst, or is even restricted to the actual line of video signal to be recorded. Preferably, the video decoder is configured to firstly digitize the analog video signal before then decoding in fast lock-on digitally on the basis of DSP algorithms implemented both hardware and software oriented.

Preferably, the video signal recording means records the multiplexed video signal digitally decoded on a video tape or a hard disk or on some other digital mass storage medium such as CD-R, CD-RW or DVD. Recording in the form of digital data is of advantage in that even pronounced displacements or steps in time in the horizontal synchronization in switching from one camera to the next as may occur between the individual cameras in the case of a video signal period or an integer number multiple thereof can now be tolerated with no problem since in digital recording there is no need for a field-synchronized recording and there is no need to take into account the mechanical mass inertia of the recording system.

To reliably maintain the deviations within the specified tolerance, the reset signal is transmitted regularly (pulsed), preferably at the frequency of 6.25 Hz for PAL and at the frequency of 7.5 Hz or 15 Hz for NTSC. This results in a resynchronization preferably within the field synchronization pulse sequence and preferably after every 8 fields with PAL or after every 4 or 8 fields with NTSC in thus enabling a typical PAL sequence of 8 fields to be commuincated complete, which is of advantage for decoding the color signals by the video signal decoder, especially when using a comb filter to separate the luminance component from the chroma components; this applying correspondingly to NTSC.

In accordance with yet another preferred embodiment, the multiplexer comprises a simple electronic analog signal switcher. In this embodiment, only one video input is needed for the video signal recording means. Switching from one camera to the other is done by the electronic switcher which by semiconductor control switches each of the video signals of the connected cameras to an output terminal. This switcher needs to undertake no decoding/recording or vice-versa of the video signals whatsoever in thus making it cost-effective in production. It is, of course, just as possible to integrate the multiplexer in the video recording means, in which case each camera is directly connected to the video recording means.

In accordance with yet another preferred embodiment, the multiplexer is controlled by the video recording means via an interface, preference being given to an USB interface, although of course other interfaces, such as parallel interfaces (Centronics and the like), RS232 or proprietary formats, are just as suitable. The video recording means can time the switching action, for example by extracting framing pulses from the video signals furnished from the multiplexer to the video recording means and/or it can dictate which camera is to be recorded at any one time. This example embodiment has the advantage that although no special coding signals need to be contained in the video signals of each camera, the image position in the recorded frame sequence can be dedicated to the input of the multiplexer from which the image came.

In accordance with still another advantageous example embodiment, the multiplexer includes a controller which via an interface, preferably an USB interface, informs the video recording means for each image a camera identification information, for example an identification number of the camera communicating at present with the output of the multiplexer or which of the inputs of the multiplexer is communicating at present with the output. This information is recorded by the video recording means together with the image concerned, preference being given to also including the time of day in the recording. This embodiment has the advantage that the multiplexed recorded images on playback can be reassigned to the corresponding inputs of the multiplexer even then when no specific sequence was maintained or when the sequence is variable. The controller comprises, for example, a microcontroller and is preferably programmed to communicate each input of a cluster of inputs of the multiplexer cyclically to the multiplexer output in thereby allowing a user to set the frequency with which the multiplexer communicates any one input to the output and thus the distribution of the image rate recorded by the video tape to the cameras individually for each camera as desired by the user. Preferably, the multiplexer comprises a means for detecting when an individual camera is down and the controller can be programmed so that when detecting a camera down the multiplexer input belonging to that camera is taken out of the cluster of multiplexer inputs communicated cyclically to the multiplexer output and/or includes the corresponding input in the cluster when a satisfactory camera signal is detected. The means for detecting a camera down may include, for example, a synchronization extractor for each input of the multiplexer which locks on to horizontal and/or vertical synchronization signals contained in the video signals furnished by each camera and generates a signal for the controller when no lock-on status exists. Likewise preferred in this case is an alert signal being sent to the user. As an alternative, the means for detecting when a camera is down may include a synchronization extractor which locks on to the horizontal and/or vertical synchronization signals contained in the output signal of the multiplexer and sends a signal to the controller when no lock-on status exists. This alternative for detecting when a camera is down has the advantage that only one synchronization extractor is needed for the plurality of channels. In this alternative, however, the down camera is not discovered instantly but only when the assigned input of the multiplexer is switched to the output of the multiplexer.

The video recording means comprises in accordance with still another advantageous embodiment also at least one video encoder for playing back the recorded images. For example, a separate video encoder is provided for each channel for playback to permit simultaneous playback of a plurality of channels. In accordance with another aspect, a single video encoder suffices to play back any one channel selected of the channels recorded in the frame mode or to play back several channels simultaneously but reduced in size on a monitor (multi-image display).

In playing back the images recorded by the video recording means, a video signal standard, for example the PAL standard, is preferably maintained. Thus in recording and later playback a reconversion of the multiplexed signals not conforming to standard because of permitting time displacements between the multiplexed signals into signals conforming to standard is achieved so that commercially available TV and video monitors can be used for displaying these signals.

Preferably an advanced, multicore cable comprising all relevant lines can be used for connecting the cameras to the multiplexer, specially preferred being a cable/connector system in accordance with the RJ-45 standard as is usual in computer networking (fast Ethernet) and in telecom applications.

The RJ-45 connector plug was defined by ISO/IEC JTC1/SC25/WG3 as standard IS 11801 and is a component of the universal cabling system in accordance with ANSI/TIA/EIA 568A. Of all data connectors in computer networking it is the most popular. This 8-core cable can be provided with male connectors by simply crimping the same and it is provided with a lock in the socket (modular western connector) and the materials are relative inexpensive. This can be made use of to advantage by the fact that such cables already exist in many cases. In modern office buildings, usually more network and telephone sockets are installed than is needed so as to enhance flexibility in making use of office space. In this case such sockets can be made use of directly for the video surveillance system in accordance with the invention simply by reconnecting in the patch panel.

Preferably integrated in the 8-core cable are all relevant wires (video, reset, 12 V, GND, alarm), the power supply for the cameras preferably being furnished by the video recording means or multiplexer so that power supply components can be eliminated for the individual cameras. The cable connections can be made without 240 V work, the cable lengths corresponding roughly to that as usual in RG 59 applications.

Since the impedance of the cable with 100 Ohm in accordance with this preferred embodiment deviates from the usual video standard (75 Ohm coaxial), all elements involved are best adapted to this impedance to achieve optimum picture quality.

In accordance with the invention, the cameras are intra-synchronized by a special technique to eliminate the need for an expensive digital multiplexer. For cabling, inexpensive cables designed for simple laying as used in the computer field (Ethernet) can be put to use; one sole cable preferably handling all requirements.

The present invention will now be detailed by way of a preferred embodiment with reference to the attached drawings in which:

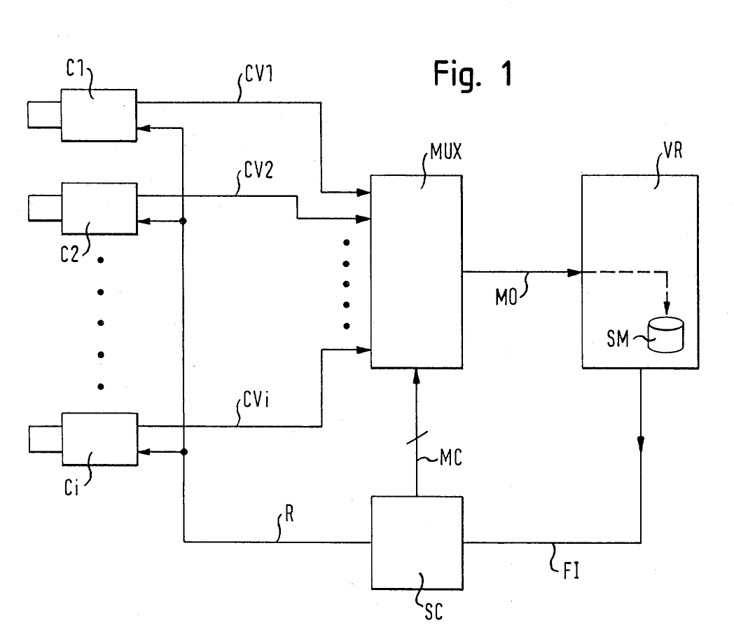

FIG. 1 is an overview block diagram of an example embodiment of the video surveillance system in accordance with the invention;

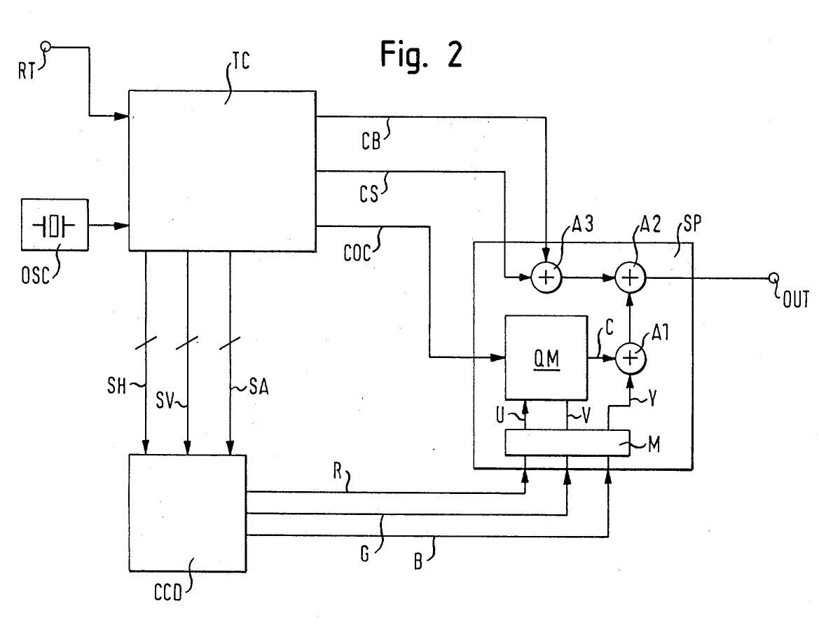

FIG. 2 is an example embodiment of a camera for the video surveillance system in accordance with the invention;

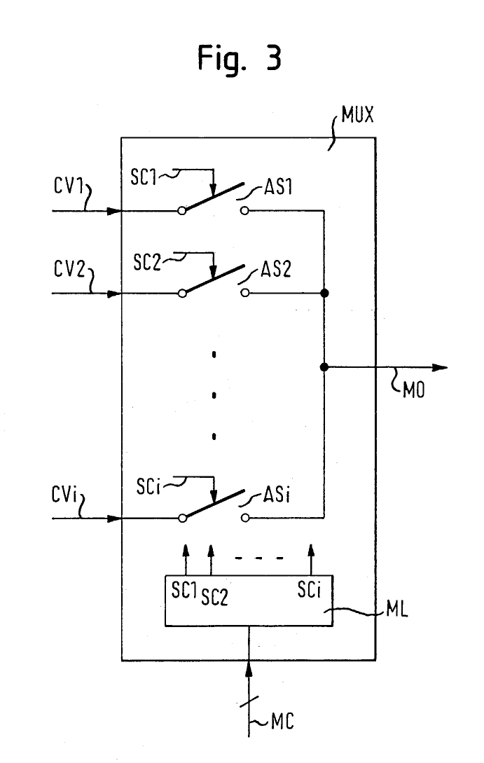

FIG. 3 is an example embodiment of the video multiplexer in the video surveillance system in accordance with the invention;

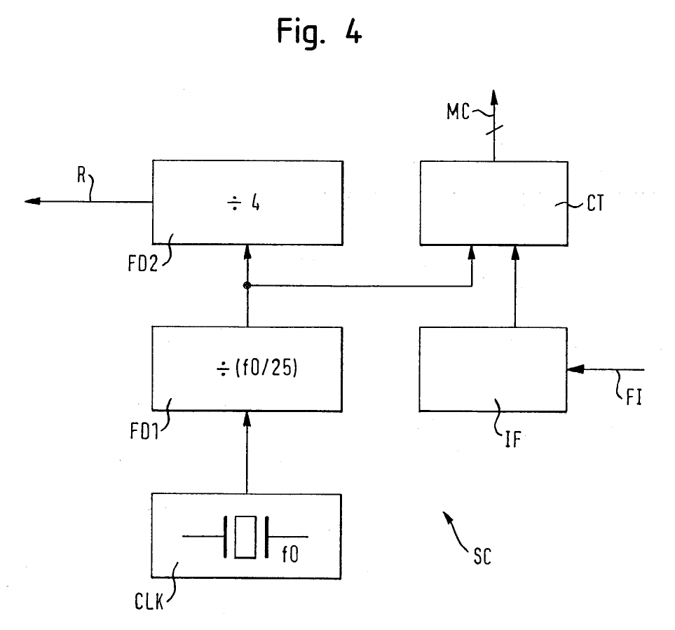

FIG. 4 is an example embodiment of the controller for the video surveillance system in accordance with the invention; and

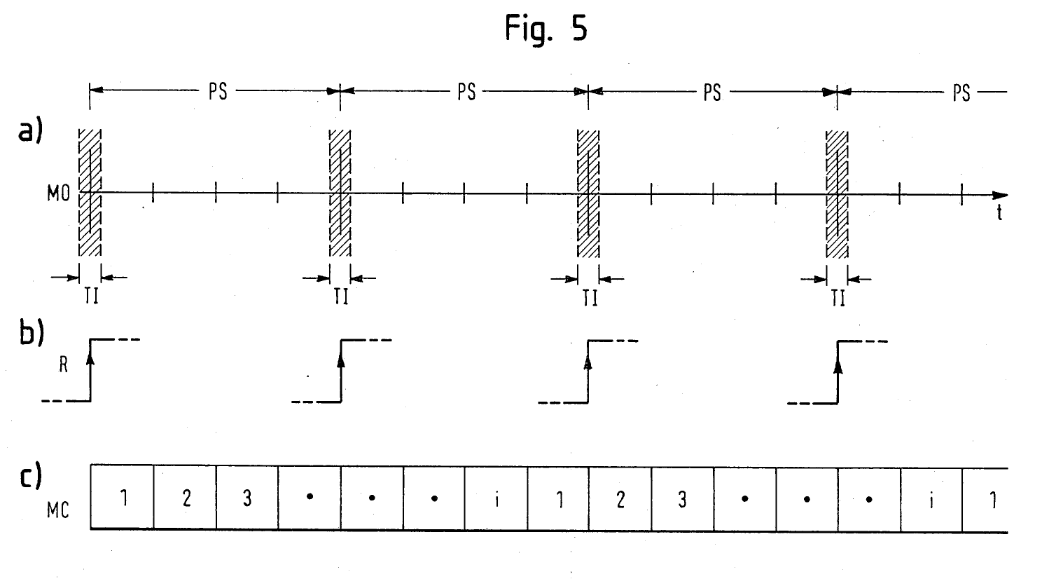

FIG. 5 is a timing diagram to assist explaining the function of the video surveillance system shown in the overview of FIG. 1.

Referring now to FIG. 1, there is illustrated an overview block diagram of an example embodiment of the video surveillance system in accordance with the invention. In this Figure, C1, C2, . . . , Ci each designate a video camera as may be sited at various locations of a building, property or public facilities requiring surveillance as a visual security function. MUX designates an analog video multiplexer including a number of analog video inputs, one each being needed separate for each camera Ci to be connected to the multiplexer MUX. MO designates an output of the analog video multiplexer MUX on which the video signals are available at the input of the multiplexer in time-multiplex, meaning that each of the signals at the input of the multiplexer can be communicated one after the other for a specific time interval to the output whilst the remaining camera signals are not communicated to the output MO. The multiplexer MUX thus multiplexes the signals of the cameras C1 to Ci in the sense of providing at its output MO a cyclic sequence of signal sections from each of the cameras C1 to Ci. VR designates a video signal recording means which is connected to the output MO of the multiplexer MUX for recording the output signal of the multiplexer. SM designates a medium for storing the image data contained in the video signal available at the output MO. In the preferred embodiment as shown in FIG. 1, the storage medium SM is a hard disk serving to store the digitized decoded image data at the output of the multiplexer MUX following compression of this data by an image compression algorithm, for example in accordance with the JPEG standard or MPEG standard. Of course, instead of a hard disk, any other suitable storage medium can be used as storage medium. For example, the image data available at the output MO of the multiplexer MUX can be recorded on a suitable magnetic tape or an optical disk storage medium, e.g. a CD-ROM or DVD for once-only or multiple writing can be used to store the image data. Optical disk storage medium for once-only writing such as DVD-R, DVDandR, CD-R are particular of advantage for this purpose since they thwart subsequent manipulation of the stored data or at least are a tell-tale for such manipulation.

In the example embodiment as shown in FIG. 1, SC designates a system controller for controlling, on the one hand, the multiplyexer MUX and, on the other, furnishes a reset signal to the cameras C1, C2, . . . , Ci. R designates a cable from the system controller SC to an input on each camera C1, C2, . . . , Ci for receiving a reset signal.

MC designates in this example embodiment a plurality of binary control lines via which digital selection control signals can be communicated to the multiplexer MUX as generated by the system controller SC. These selection control signals communicated via the selection lines MC to the multiplexer MUX dicatate which of the inputs of the multiplexer, and accordingly, which of the video signals CV1, CV2, . . . , CVi generated by the video cameras is to be communicated to the output MO of the multiplexer MUX. Although a parallel signal format is illustrated for these selection control signals, it is, of course, just as possible as an alternative to communicate the selection control data to the multiplexer MUX serially.

F1 designates a control line leading from the video signal recording means VR to the system controller SC. It is via this control line that the video signal recording means VR furnishes data to the system controller SC as to which of the video channels CV1, CV2, . . . , CVi is to be recorded next. Thus, in accordance with this example embodiment, the video signal recording means VR controls selection of the cameras to be recorded at present and determines the sequence in which the channels are recorded. Because this data in this example embodiment is generated by the video signal recording means VR, there is no need in this example embodiment for identifying the channels in the video signals generated by each of the video cameras C1, C2, . . . , Ci or for a device inserting such a channel identification as a function of the select signals MC in the output signal MO of the multiplexer MUX. However, the example embodiment as shown in FIG. 1 of a video surveillance system may, of course, be configured such that the channel select data is not generated by the video recorder VR but that each of the video cameras C1, C2, . . . , Ci contains a channel identification, for example in the signal sections provided in the vertical synchronization of the video signals generated in each of the cameras, or the system controller SC may include additional devices not shown in FIG. 1 for inserting such channel identification in the output signal MO of the multiplexer MUX. The channel select data generated by the video signal recording means VR available via the control line FI or the channel identification serve to demultiplex the recorded images on playback, i.e. to assign the recorded images to their corresponding channels and to permit playback of the images belonging to a channel independently of the images belonging to the other channels.

The cameras C1, C2, . . . , Ci as shown in FIG. 1 of the example embodiment may be configured to generate FBAS video signals CV1, CV2, . . . , CVi in accordance with the PAL standard or in accordance with the NTSC standard, or, in the least expensive case, the cameras C1, C2, . . . , Ci may be black-and-white cameras. To advantage the system controller SC generates a reset signal R for these cameras having a nominal period corresponding to the nominal period of the video signals generated by each of the video cameras or is an integer number multiple of the nominal period of the video signals generated by the cameras. The video cameras C1, C2, . . . , Ci are reset by the reset signal R into a defined starting status, which is the same for all video cameras and is undertaken simultaneously by the reset signal. On the basis of this starting status, the video cameras work free-running. until the next reset signal occurs which, due to the tolerance of the clock oscillators provided in the cameras, result in the synchronization of the video signals furnished by the individual cameras become progressively lost until the next reset signal R is generated. The nominal frequency for the reset signal, in the case of the PAL standard is preferably 6.25 Hz corresponding to 8 fields and thus corresponding to the nominal period of the PAL signal. If NTSC synchronization signals are generated by the cameras, a nominal period for the reset signal of 8 fields is likewise suitable which for NTSC with 30 frames per second means a nominal frequency for the reset signal R of 7.5 Hz.

It is, of course, also so that the reset signal R is subject to a certain tolerance, and also the period of the reset signal R will deviate within these tolerances from the nominal period. The example embodiment as shown in FIG. 1 is of particular advantage in that it is compatible with such tolerances whilst still furnishing a satisfactory recording of the images furnished by the cameras C1, C2, . . . , Ci in a cyclic sequence. In the example embodiment as shown in FIG. 1, the controller SC ensures that within the time tolerances of the video signals CV1, . . . , CVi generated by each camera and the reset pulse R communicates each of the cameras alternately roughly for the duration of a frame to the output MO of the multiplexer MUX, in accordance with the frame identification information as furnished by the video signal recording means VR to the controller SC. Due to the time tolerances, every time a switch is made from one video channel to the next, displacements or shifts in time result in the output signal MO of the multiplexer, since the video cameras in this example embodiment are free-running between the individual reset pulses. These displacements are evident, for example, from two horizontal synchronization pulses between which a switch to the next channel has occurred, are spaced from each other nearer or farther than those of the previous and subsequent horizontal synchronization pulses. Such a displacement in time is particular evident in the phase of the burst for regenerating the color subcarrier if the respective cameras generate color signals conforming to the FBAS standard. In the output signal MO of the multiplexer MUX two bursts in sequence, between which a switch has been taken place from one channel to another, no longer have a predictable phase relationship to each other when commercially available quartz crystals are used for the clock oscillators in the cameras and in the system controller SC which, for example, have a tolerance of 20 ppm.

In the example embodiment as shown in FIG. 1, the video signal recording means VR is designed so that it is able to satisfactorily process the video signal at the output MO of the multiplexer MUX despite the time shifts or displacements occurring therein. In the example embodiment as shown in FIG. 1, the video signal recording means VR comprises for processing the video signal furnished by the multiplexer MUX a video signal decoding circuit which decodes the video signal fully digital by analog/digital conversion of the complete FBAS video signal at a sampling rate of, for example, 27 MHz, extracting the horizontal-vertical synchronization, regenerating the color subcarrier, separating the luminance and chroma signal components and QAM demodulation of the chroma signal with the aid of the regenerated color subcarrier by means of digital signal processing algorithms. The digital image signal components Y, U, V or R, G, B obtained therefrom are then recorded in the video signal recording means on a digital mass storage medium as already described. The video signal decoder in the video signal recording means VR in accordance with the present example embodiment is operated for regenerating both the horizontal synchronization and the color subcarrier in a fast-locking mode which for regenerating this data recourses merely to a time window in the video signal to be processed. Such fully digital video signal decoding circuits are commercially available as integrated circuits, for example, the Philips SAA 7113 is suitable for decoding the video surveillance system in the fast-locking mode.

However, it is, of course, just as possible to make use of other video signal decoding circuits for decoding the output signal MO furnished by the multiplexer MUX. As an alternative to all-digital decoding as achieved, for example, in the Philips SAA 7113 decoder, these functions may be achieved, of course, by conventional analog or partly by analog, partly by digital means from a wealth of circuits available to the person skilled in the art in video signal processing. For extracting the horizontal-vertical synchronization as well as the color subcarrier, use is made usually of phase-locked loops (PLLs). And, of course, such circuit architectures are just as suitable for the example embodiment as shown in FIG. 1 when the PLL for regenerating the color subcarrier is designed to permit fast locking to phase shifts caused by the multiplexer switching from one camera to the next.

This ability to quickly react to such shifts in phase can be achieved by various ways and means. For example, the number of color subcarrier bursts used for tracking the phase of the regenerated color subcarrier can be restricted in time, for example with the aid of a rectangular or cosine window function as applied to the video signal to be decoded or the color subcarrier burst extracted therefrom. This window function defines the time context used for regenerating the color subcarrier and prevents a history of phase shifts disrupting regeneration of the color subcarrier. In accordance with the time extent of the window function, the bandwidth of the PLL is set sufficiently high. When the video cameras C1, C2, . . . , Ci generate color signals in accordance with the PAL standard, it is of advantage for both burst phases to provide a separate control loop implemented in the software for a digital signal processor or in the hardware and to apply the windowed bursts alternately to the two PLLs. The width of the time window in this arrangement is selected so that it does not exceed the duration of the field synchronization pulse sequence between the fields in each case. Preferably, the cameras C1, C2, . . . , Ci generate no burst during the field synchronization pulse sequence. Since switching from one camera to the next by the multiplexer MUX in this example embodiment occurs preferably during the field synchronization pulse sequence between the fields, this avoids the circuit for regenerating the color subcarrier in the video signal decoder having to process a train of bursts having an unpredictable phase relationship.

In addition, or as an alternative to the means as cited, the video signal decoder circuit in the video signal recording means VR may also make use of the fact that in the example embodiment as shown in FIG. 1 switching by means of the multiplexer MUX from one camera to the next is done at the frame repetition frequency during the field synchronization pulse sequence. This is why the video signal decoder circuit uses for extracting the color subcarrier and/or for extracting the horizontal synchronization from the video signal to be decoded to advantage not the signal components as received prior to the last frame repetition but instead restricts the signal section from the video signal to be decoded to the actual frame when extracting the horizontal synchronization and/or regenerating the color subcarrier.

The video signal recording means VR in the example embodiment as shown in FIG. 1 comprises in addition means (not shown) for playback of the recorded images. To permit assigning the recorded sequence of images to the channels in each case, i.e. the video cameras from which these images originate, during playback, the video signal recording means VR records in the example embodiment as shown in FIG. 1 the images furnished by the individual cameras C1, . . . , Ci in a predefined time sequence or in a sequence as dictated by the video signal recording means VR itself via the control line FI to the system controller SC. Thus, on playback, the video signal recording means VR feeds the recorded images in the sequence of their recording to a series of output channels. In this arrangement, the assignment of recorded images to the corresponding output channels is explicitly possible solely from the sequence of the recorded images since this sequence, or if predefined, the position of at least one specific channel in the sequence of the recorded images was dictated by the video signal recording means VR itself by means of the control line FI. The video signal recording means VR communicates in this example embodiment the digital recorded images, belonging to the same channel, to a corresponding video signal encoder which generates from this image frequency of the corresponding channel a standardized video signal permitting display on standard TV or video monitors. Because in this example embodiment a plurality of cameras divide the frame rate on recording, in each playback channel the frames are repeated in accordance with the number of channels recorded so as to regenerate a standardized frame rate on playback. This demultiplex function and regenerating the frame rate by repeating the playback frame is preferably realized totally digitized. For converting the resulting digital image signal into a standardized FBAS video signal for display on a standard monitor, a wealth of integrated circuits specially devised for this purpose are available on the market. For example, the Philips SAA 7126 is a commercially available module suitable for handling this function. For each playback channel one such video encoder is provided. In the example embodiment as shown in FIG. 1, the frames of each and every channel are read into a corresponding frame buffer store which is read out by the corresponding video signal encoder as often as the number of channels divided by the frame recording rate of the video signal recording means VR before the controller of the frame buffer store of each channel is updated by reading out the next frame belonging to the channel concerned from the mass storage means SM.

Referring now to FIG. 2, there is illustrated an example embodiment of the video cameras C1, . . . , Ci in the system as shown in FIG. 1 whereby each of the cameras Ci may be structured identical as shown in FIG. 2 as an example.

The video camera shown in FIG. 2 comprises a CCD image converter identified in FIG. 2 as CCD, a variety of which are commercially available from various manufacturers. The example embodiment as shown in FIG. 2 shows a block diagram of a color video camera. R, G and B designate the analog video signal outputs of the color image CCD converter. SP designates a video signal processing block comprising a matrix M in which the R, G and B signals furnished by the CCD image converter are transformed by the known ways and means into a luminance signal Y as well as into two chroma signal components U and V by linear overlay. The video signal processing block SP comprises in addition a quadrature modulator QM which receives a color subcarrier signal COC and amplitude-modulates the color signals U, V on the color subcarrier quadrature to obtain a chroma signal C. A1 designates an adder which adds the luminance signal Y and the chroma signal C. This added signal is supplemented in a further adder A2 by further signal components CS for horizontal and vertical synchronization for furnishing at the output OUT a standardized FBAS video signal. The color subcarrier signal COC as well as the blanking, horizontal and vertical synchronization pulses CS including the burst signal CB which is added to the output signal in the adder A3 are furnished by a timer circuit TC. Such timer circuits are commercially available in integrated form from a variety of manufacturers, just like ICs which implement the video signal processing functions as just described. OSC designates a circuit for generating a clock signal for timing the sequences in the timer circuit TC. The clock oscillator OSC comprises a quartz crystal having a commercially available accuracy of 20 ppm, for example.

The timer circuit TC generates in addition in synchronization with the signals CB, CS and COC also the signals for controlling the CCD image converter. These control signals include control signals SH for the horizontal synchronization of the CCD image converter matrix, as well as signals SV for the vertical synchronization in reading out the CCD image converter matrix, and also including analog signals SA for setting such working points, such as exposure, shutter timing, DC voltage levels, etc., for the CCD image converter matrix.

RT designates a terminal of the timer circuit TC for receiving an external reset signal. Every time the timer circuit TC of the video camera in the example embodiment as shown in FIG. 2 receives at the reset input RT an external reset signal, the timer circuit TC assumes a predefined starting status and starts on the basis thereof with generating the blanking and synchronization signals CS, the burst CB and the color subcarrier signal COC for the signal processor SP, it also controlling reading out of the CCD image converter via the corresponding control signals SH, SV and SA. Thus, when, as shown in FIG. 1, such a reset signal R is supplied from the system controller SC to each of the video cameras, of which an example embodiment is shown in FIG. 2, via each of their reset signal input terminals RT, then each video camera begins on the basis of this reset signal to regenerate a FBAS video signal, on the basis of a defined status, so that all video cameras commence at the same point in the cycle of a standardized FBAS video signal. This point is usually the start of the first field, but could just as well be any other point in the cycle of standardized FBAS video signals as long as all cameras commence cycling at the same point in response to the reset signal.

The reset signal input RT in the video camera as shown in FIG. 2 is brought out to permit a simple termination of the line communicating the reset signal from the system controller SC as shown in FIG. 1 to each of the cameras. Preferably, the camera as shown in FIG. 2 is configured so that in the power supply terminals for the circuit components of each of the cameras, the output terminal OUT at which the camera furnishes the FBAS video signal, as well as the reset signal terminal RT are placed on various contacts of one and the same plug or socket accessible external on the camera, or as protected behind a lid or cover. Provided preferably on the camera is an RJ-45 standard socket as popular in the computer network field (fast Ethernet) and as usual on telecom hardware. It will be appreciated that although the example embodiment as shown in FIG. 2 and as described above relates to a CCD camera, any other type of camera may be used in accordance with the invention, of course, for example using a SRAM or a Vidicon as the image converter.

Referring now to FIG. 3, there is illustrated an example embodiment of the multiplexer as put to use in the example embodiment of the video surveillance system as shown in FIG. 1. This comprises a plurality of analog switches AS1, AS2, . . . , ASi. For each signal input CV1, CV2, . . . , Cvi, a corresponding analog switch is provided, each of which has a signal input and a signal output. Each analog switch connects its signal input and its signal output from a signal flow point of view in accordance with a control signal SC1, . . . , SCi. Circuit-wise, each analog switch is usually configured as an amplifier circuit characterized in that its gain can be switched according to the respective binary control signal SC1, [symbol] , Sci, in general between 0 and a value higher than 0, for example between 0 and approximately 1 or between 0 and approximately 2.

As evident from FIG. 3 the multiplexer MUX is circuited so that each input signal CV1, CV2, . . . , Cvi of each camera is applied to the input of a corresponding analog switch AS1, AS2, . . . , ASi. The outputs of the analog switches AS1, AS2, . . . , ASi are intercoupled and represent the output terminal MO of the multiplexer MUX. Thus, irrespective of which analog switch AS1, AS2, . . . , ASi was just through-connected by its corresponding controller signal SC1, SC2, . . . , SCi at the time, the corresponding signal input CV1, CV2, . . . , CVi is switched from the corresponding video camera to the output MO of the multiplexer MUX.

ML designates a logic circuit component serving to recode the parallel or serial selection control signal MC usually available in binary coded form for selecting one of the analog switches AS1, AS2, . . . , ASi of the multiplexer MUX so that for each switch an individual control signal is available whose level is controlled by the binary coded selection control signal MC. In this arrangement, for every binary value as may be represented by the selection control signal MC there is only one control signal SCi at the most which assumes a level so that its assigned analog switch communicates. Accordingly, the selection control signal MC never communicates more than one of the video signals CV1, CV2, . . . , CVi to the output MO of the multiplexer MUX.

The multiplexer MUX in the example embodiment as shown in FIG. 3 is achievable to advantage on the basis of commercially available analog video multiplexer circuits, for example, in the form of integrated circuits. One such integrated circuit suitable for the multiplexer is the Maxim MAX4312.

Referring now to FIG. 4, there is illustrated an example embodiment of the system controller SC as shown in FIG. 1 in which CLK designates a quartz crystal oscillator furnishing a clock signal of the frequency f0. The quartz crystal may be accurate to, for example, 20 ppm, the nominal frequency f0 of which may be, for example, 1 MHz, as commercially available. FD1 designates a first frequency divider which receives the clock signal generated by the clock oscillator CLK as the input signal and subjects this signal to a frequency division with a ratio selected so that the output signal of the first frequency divider FD1 comprises a nominal frequency corresponding to the frame repetition nominal frequency of the video signals generated by the cameras C1, C2, . . . , Ci. For the PAL standard the frame repetition nominal frequency is 25 Hz. Accordingly, the first frequency divider FD1 is configured to divide the clock signal furnished by the clock oscillator CLK by a value of (f0/25).

FD2 is the designation of a second frequency divider serving to divide the signal output by the first frequency divider FD1 with a nominal frequency of 25 Hz again by 4 to obtain a signal R whose nominal period equals the nominal period of the video signal generated by the video cameras in accordance with the PAL standard. The standardized PAL signal comprises a periodicity of 4 frames resulting in the value of 4 by which the second frequency divider FD2 divides the first signal from the frequency divider FD1. The resulting signal R is furnished by the system controller to the reset inputs of each camera C1, C2, . . . , Ci to reset them 6.25 times per second (nominal value).

The signal furnished by the first frequency divider FD1 with a nominal frequency equaling that of the frame refresh frequency serves to generate the signals MC for driving the multiplexer such that the multiplexer switches from one camera to the next with a nominal frequency equaling that of the frame repetition frequency. This switching signal is generated in a fixed time relative to the reset signal R such that the video cameras are reset by means of the reset signal R at a point in time which substantially coincides with the point in time in which the multiplexer MUX switches from one camera to the next. This relationship is assured in the example embodiment as shown in FIG. 4 by the second frequency divider FD2.

CT in FIG. 4 designates a binary counter circuit with n binary outputs so that 2ⁿ is greater than or equals the total system connection capacity of video cameras C1, C2, . . . , Ci, i.e. the number of inputs of the multiplexer MUX. The counter CT receives as the input signal the output signal from the first frequency divider FD1 so that the output signals MC of the counter CT have a switching frequency equaling that of the vertical synchronization frequency at the output of the first frequency divider FD1.

IF designates an interface circuit provided to receive from the video signal recording means VR a channel identification information, serving to mark a specific position in the sequence of images recorded thereby, for example position 1, with a video signal from a terminal of the video signal multiplexer known thereto, for example the first terminal CV1, so that the video signal recording means VR in “seeing” this together with the fact that the locations of the recorded image frequency are each cyclically marked is able to assign the recorded images to the individual display monitors or output channels without any further channel identification on playback. For this purpose, the video signal recording means VR sends a channel identification signal to the interface circuit IF cyclically which converts this signal into a signal for setting the counter CT. On receiving this setting signal, the counter CT assumes a predefined status and thus selects a predefined input of the multiplexer for communicating the output of the multiplexer as soon as the next pulse is sent to the counter input of the counter CT by the first frequency divider FD1.

Whilst the example embodiment as shown in FIG. 4 shows two separate frequency dividers FD1, FD2 as well as a separate counter CT, it is possible to combine these functions partly or fully in a single logic circuit. The block diagram as shown in FIG. 4 serves the purpose of representing the structure and function of the system controller SC as an example without this structure restricting the scope of the present invention to the example embodiment as shown. It is likewise just as possible to conceive a wealth of modifications to the mechanism for identifying the channels by the video signal recording means VR. Thus, as an alternative to the example embodiment as just described, it is possible that the video signal recording means VR handles the complete control of the multiplexer MUX directly without the system controller SC synchronizing generation of the selection control signals MC for the multiplexer MUX. In accordance with this alternative, the video signal recording means generates the channel identification information and produces therefrom the selection control signal MC which clocks the detected vertical synchronization pulses in synchronization to the video signals furnished by the video signal recording means VR at the output MO of the multiplexer. In accordance with another example embodiment of the system controller SC, it receives no channel identification signal FI from the video signal recording means VR, it instead generating a channel identification signal in accordance with the selection control signal MC, for example, by inserting corresponding binary pulse sequences into one or more of the first lines following a field repetition. In accordance with this variant, these channel identification pulses generated by the system controller SC and inserted into the output signal of the multiplexer MO are then used by the video signal recording means VR either in recording or in playback for channel identification and assignment.

Whilst FIG. 4 depicts a quartz crystal oscillator, as an alternative thereto, use can be made also of the component of a supply voltage changing in time, for example the line frequency of 50 Hz in Europe or 60 Hz in the USA for generating a timing signal. In this case the first frequency divider FD1 is configured with a dividing ratio adapted to the line frequency, for example of 2, or it may even be total eliminated to clock the multiplexer at the field frequency.

Referring now to FIG. 5, there is illustrated a timing diagram for explaining how the example embodiment, as shown in the previous Figures and explained, works. FIG. 5 comprises three components 5a), 5b) and 5c). FIG. 5a) shows a time axis t for representing greatly simplified the video signal at the output MO of the video signal multiplexer MUX. The sections marked by longer vertical lines in FIG. 5a) identify a complete PAL sequence as indicated by the letters PS above the time axis in FIG. 5a). Each PAL sequence comprises four frames as indicated by the shorter vertical lines in FIG. 5a). As already mentioned, a standardized PAL signal, more particularly, the sequence of synchronization pulses and color subcarrier bursts have a period of eight fields. In other words, this sequence of synchronization pulses and color subcarrier bursts is repeated every eight fields.

The vertically arranged, hatched zones in FIG. 5a) mark a tolerance interval with a width TI as indicated below FIG. 5a). The meaning of this tolerance interval will be detailed in the following.

FIG. 5b) depicts diagrammatically a flank of the reset signal R generated periodically for resetting the cameras C1, C2, . . . , Ci of the video surveillance system. In the example embodiment as shown in FIG. 5, the reset signal R is generated with a nominal period corresponding to that of the complete PAL sequence PS. Accordingly, the flanks triggering the reset in FIG. 5b) are depicted vertically oriented by the longer vertical lines in FIG. 5a) identifying the limits of the PAL sequence. There is, of course, no mandatory requirement for selecting the flank position for the reset signal R in FIG. 5b). The video cameras C1, C2, . . . , Ci may be designed so that to implement a reset on a positive flank at each of their reset inputs RT, as shown in FIG. 2, it being just as possible to design each of the video cameras so that the reset is triggered on a negative flank or as a function of the signal level. All of these alternatives are obvious to the person skilled in the art in the light of present invention.

FIG. 5c) is a diagrammatic representation of the time profile of the selection control signal MC. This FIG. 5c) does not represent signal amplitudes but diagrammatically the binary value of the selection control signal dictating each input 1 to i of the multiplexer MUX communicated at any one time to the output MO of the multiplexer MUX. As already explained in conjunction with FIG. 4, the reset signal R and the select signal MC in the example embodiment as shown in FIG. 4 is generated synchronized by the system controller SC such that the reset signal R substantially coincides with the point in time for switching from one input of the multiplexer MUX to the next. Accordingly, in FIG. 5c) the transitions from one signal input to the next of the multiplexer MUX vertically oriented are shown by the flanks of the reset signal R prompting camera reset.

In operation, the video signals generated by each of the video cameras C1, C2, . . . , Ci are each subject to tolerances in time as dictated by the precision of the quartz crystals used in each camera. More particularly, for a cost-effective solution it is of advantage to employ commercially available quartz crystals having usual tolerances in the cameras. Thus, the actual period of the PAL sequences generated by each of the cameras falls in a given tolerance interval TI about the nominal period of the PAL sequence, the width of the tolerance interval shown hatched in FIG. 5a) depending on how accurate the quartz crystals are as used in the cameras. Thus, when all cameras as prompted by the reset pulse R start simultaneously to generate a PAL sequence, the end of the PAL sequence for each camera falls within the tolerance interval TI as shown hatched in FIG. 5a). The tolerance intervals for the frame limits depicted by the small vertical lines in FIG. 5a) are a linear fraction of the tolerance interval TI. For example, the tolerance interval for the first frame limit is ¼ of the tolerance interval TI whilst the tolerance interval TI for the third frame limit is ¾ wide.

However, it is not only the video signal generated by each camera that is subject to time tolerances due to tolerances of the quartz crystals used in the cameras and the free-running of the cameras between the reset pulses in each case, but also the reset pulses R themselves are generated by the system controller SC with a period which is subject to certain tolerances. In the example embodiment as shown in FIG. 5, the reset pulse is generated with such a period that it lies within the tolerance interval TI for the period of the PAL sequence PS of the video signals generated by each video camera. Where the accuracy of this period of the reset signal R satisfies this requirement, the maximum time distortion capable of occurring in the video signal at the output MO of the multiplexer MUX, due to the inaccuracy of the reset signal period within these limits, is not greater than the tolerance interval TI dictated by the quality of the quartz crystals employed in the cameras. This requirement in generating the reset signal R can be satisfied with no problem by employing a quartz crystal for the clock oscillator CLK in the system controller SC as shown in FIG. 4 whose tolerance is not less than that of the quartz crystals used in the cameras. In the example embodiment as shown in FIG. 5, preference is given to commercially available quartz crystals having an accuracy of 20 ppm so that for the system controller SC a quartz crystal having the same accuracy of 20 ppm is adequate.

The video signal decoding circuit in the video signal recording means VR as shown in FIG. 1 is thus set to lock onto the horizontal synchronization pulses contained in the video signal and bursts for regenerating the color subcarrier so quickly that it can handle the time distortions to the amount of the tolerance interval TI as shown in FIG. 5 in the video signals at the output MO of the multiplexer MUX without the images being disrupted thereby.

Whilst the above described a preferred example embodiment of the present invention with reference to the drawings, the person skilled in the art will appreciate the many modifications possible without exceeding the scope and extent of the present invention. Whilst the example embodiment as described relates to the PAL signal format, it is just as possible to make use of the NTSC signal format or any other video signal format. Whilst in the example embodiment as described the reset signal R is generated with a nominal period corresponding to that of the PAL sequence, it is just as possible to generate the reset signal R with a period which is an integer number multiple, for instance 2, 3 or 4 times of the nominal period of the PAL sequence. If NTSC signals are used, the nominal period of the reset signal R corresponding to the nominal period of the frame repetition or likewise an integer number multiple thereof. The groupings of the function blocks as shown in the Figures merely serve to assist explaining the example embodiment described without the present invention being restricted in accordance with such groupings. For example, it is just as possible to integrate the multiplexer MUX in the video signal recording means VR although this is shown as a separate block in FIG. 1. The system controller SC can be integrated in the multiplexer MUX or likewise in the video signal recording means VR. The video signal recording means VR may be configured as a separate video recorder or as a plug-in. Likewise, the video signal recording means VR and, where necessary, the system controller SC and/or multiplexer MUX components integrated therein may be configured as an extension card for a computer, for instance a personal computer and, where present, have access to the components included in any case in the computer, for example to the hard disk, in thus eliminating the need for a separate mass storage medium SM. The video signal recording means VR may include means for playback of the recorded video signals, although this is not at all a mandatory requirement. The mass storage medium SM in FIG. 1 may be configured replaceable for insertion in a separate playback device for playing back the recorded signals. In accordance with a preferred example embodiment, the video signal recording means compresses the digitized video signals of the video cameras C1, . . . , Ci and stores the data on a mass storage medium SM compressed.

It is understood that reference symbols in the claims merely serve for a better understanding and are not to be interpreted as restricting the claims in any way.

1. A video surveillance system comprising a plurality of video cameras (C1, C2, . . . , Ci) as well as a video signal switch (MUX)including a plurality of inputs (CV1, CV2, . . . , CVi) and at least one output (MO), a means (SC) for controlling the video signal switch (MUX) and said video cameras (C1, C2, . . . , Ci), a video signal recording means (VR) connected to said output (MO) of said video signal switch (MUX);
each of said video cameras (C1, C2, . . . , Ci) comprising:
an image converter means (CCD) for receiving said images and converting them into an image signal having at least a luminance component,
a pulse generating means (TC) for free-running generation of a sequence of horizontal and vertical synchronization pulses, whereby the period (PS) of said sequence may deviate from a predefined nominal period within a given tolerance interval (TI);
a means (SP) for combining said image signal from said image converter means (CCD) and said sequence of horizontal and vertical synchronization pulses into a composite video signal;
said pulse generating means (TC) being configured to assume a predefined starting status on receiving an external reset pulse (R) and to generate the sequence of said horizontal and vertical synchronization pulses commencing with said predefined starting status;
said video signal switch (MUX) comprising means for applying said signal at a selected input of said video signal switch inputs (CV1, CV2, . . . , CVi) to said output of said video signal switch (MUX) in accordance with a selection control signal (MC);
said system controller (SC) comprising a clock generator (CLK, FD1, FD2) for generating a reset pulse for communicating it to said video cameras (C1, C2, . . . , Ci) in common;
said video signal recording means (VR) comprising a video signal decoding circuit for decoding said video signal furnished by said video signal switch (MUX) and which is configured to lock on to said horizontal synchronization pulses contained in said video signal so quickly that it is able to decode video signals comprising time distortions caused by said periods of said sequences generated by each camera deviating from said nominal period.

2. The video surveillance system as set forth in claim 1, characterized in that said selection control signals (MC) for said video signal switch (MUX) are generated so that the clocking periods from one video signal switch input to the next equals 1/M times said reset period, where M is an integer number equal to or larger than one.

3. The video surveillance system as set forth in claim 2, characterized in that M equals the number of frames per period (PS) of said periodic signal containing the sequence of horizontal and vertical synchronization pulses.

4. The video surveillance system as set forth in any of the preceding claims, characterized by a circuit for generating selection control signals, the circuit being configured to process the vertical synchronization information contained in said video signal (MO) furnished by said video signal switch (MUX) to generate said selection control signals for said video signal switch.

5. The video surveillance system as set forth in any of the claims 1 to 3, characterized in that said clock generator (CLK, FD1, FD2) contains a circuit (CT) for generating selection control signals and is configured to generate said selection control signals for control of said video signal switch (MUX) in synchronization with said reset pulses (R).

6. The video surveillance system as set forth in any of the preceding claims, characterized in that said clock generator is configured to derive said reset pulse from a time-variable component of a power supply voltage.

7. The video surveillance system as set forth in any of the preceding claims, characterized in that said video decoder circuit is configured to digitize the signal furnished by said video signal switch (MUX), to decode said digitized signal and to record it in digital form.

8. The video surveillance system as set forth in any of the preceding claims, characterized in that said video signal switch (MUX) is integrated in said video signal recording means.

9. The video surveillance system as set forth in any of the preceding claims, characterized by a means for generating a camera identification information and for inserting this information into said signal recorded by said video signal recording means.

10. The video surveillance system as set forth in claim 9, characterized in that said multiplexer (MUX) comprises a controller configured to generate said camera identification information as a function of the multiplexer input (CV1, . . . , CVi) presently communicating with said output (MO) of said multiplexer (MUX) and to forward it to said video signal recording means.

11. The video surveillance system as set forth in claim 10, characterized in that said controller for said multiplexer (MUX) is configured to control for each input individually adjustable by the user, the frequency of said multiplexer applying each input to said output.

12. The video surveillance system as set forth in any of the preceding claims, characterized in that said image signal contains a chroma component in addition to said luminance component; and said pulse generators (TC) of said cameras are configured to generate in said sequence of horizontal and vertical synchronization pulses a burst signal for color subcarrier regeneration.

13. The video surveillance system as set forth in claim 12, characterized in that said sequence of burst, horizontal and vertical synchronization pulses generated by said pulse generator corresponds to the PAL standard with a nominal period of 1/(6.25 Hz) or NTSC standard with a nominal period of 1/(15 Hz) or SECAM standard with a nominal period of 1/(6.25 Hz).

14. The video surveillance system as set forth in any of the preceding claims, characterized in that each of said video cameras (C1, . . . , Ci) is connectable to its associated input of said video signal switch (MUX) via a fast Ethernet cable which communicates in addition to the video signal from said camera also the power supply voltage as well as said reset signal to said connected camera.

15. The video surveillance system as set forth in claim 14, characterized in that the characteristic impedance of said cable is 100 Ohm and the terminating impedance of each input of said video signal switch (MUX) is adapted to said characteristic impedance of 100 Ohm.

16. The video surveillance system as set forth in claim 14 or 15, characterized in that for connecting each of said cameras to said fast Ethernet cable as well as for connecting each cable to said video signal switch (MUX) a cable/connector system in accordance with the RJ-45 standard is provided.

17. The video surveillance system as set forth in any of the preceding claims, characterized in that said video signal decoding circuit comprises;
an extraction circuit for regenerating the horizontal and vertical timing from said multiplexed output signal (MO) of said video signal switch (MUX) and generating synchronization signals on the basis of a time-limited signal window from the video signal to be decoded which is not greater than the duration of the field synchronization pulse sequence between the respective fields.

18. The video surveillance system as set forth in any of the preceding claims, characterized in that said video decoding circuit is configured to work in a fast locking mode for extracting the horizontal synchronization.

19. The video surveillance system as set forth in any of the preceding claims, characterized in that
said video signals generated by each video camera (C1, . . . , Ci) are color video signals containing bursts for color subcarrier regeneration;
and said video signal decoding circuit is configured to extract said color subcarrier in a fast locking mode.

20. The video surveillance system as set forth in any of the preceding claims, characterized in that
each said video camera (C1, . . . , Ci) is configured to generate color video signals containing bursts for color subcarrier regeneration, a time interval several lines long, in which no burst is generated, being provided between said fields; and
said video decoding circuit is configured to extract from said color subcarrier burst contained in said video signal to be decoded a color subcarrier for decoding the color information, the number of lines in sequence influencing the regeneration of said color subcarrier not being greater than said time interval between two fields in which no burst exists.

21. The video surveillance system as set forth in any of the preceding claims, characterized in that said video signal recording means is configured to record said decoded video signal digitally on a video tape or on a hard disk, CD-ROM or DVD with or without data compression.

22. The video surveillance system as set forth in any of the preceding claims, characterized in that said clock generator (CLK, FD1, FD2) is configured
to generate said reset pulse with a period selected so that 1/N times thereof lies within said given tolerance interval for said period of the sequence of horizontal and vertical synchronization pulses, where N is an integer equal to or greater than one; and
said video signal decoding circuit is configured to lock on to horizontal synchronization pulses contained in said video signal so quickly that it can decode video signals comprising time distortions to the amount of N times said given tolerance interval.

23. The video surveillance system as set forth in claim 22, characterized in that said video cameras (C1, . . . , Ci) are configured to generate video signals in accordance with the PAL standard, and N equals 1 or 2.

24. The video surveillance system as set forth in claim 22, characterized in that said video cameras (C1, . . . , Ci) are configured to generate video signals in accordance with the NTSC standard, and N equals 1, 2, 3 or 4.

25. A video camera for use in a video surveillance system in accordance with any of the preceding claims, comprising an image converter (CCD) and a resettable timing circuit (TC) for controlling generation of a standardized video signal as well as an input (RT) for receiving an external reset signal (R).

26. The video camera as set forth in claim 25, characterized by a socket or a plug with contacts for power supply of said camera, a contact for outputting said video signal generated by said video camera as well as a contact for receiving said external reset signal, said contacts all being grouped together in said one socket or plug.

27. The video camera as set forth in claim 26, characterized in that said socket or plug conforms to the fast Ethernet standard RJ45.

28. The video camera as set forth in any of the claims 25 to 27, characterized in that said image converter is a CCD image converter, a SRAM image converter or a Vidicon.

29. A video signal recording means adapted for use in a video surveillance system as set forth in any of the claims 1 to 24, including a video signal decoding circuit for decoding said video signal comprising time distortions which circuit is configured to lock on to said horizontal synchronization pulses contained in said video signal so quickly that it is able to decode video signals comprising time distortions caused by the periods of said sequences generated by each camera deviating from the nominal period.

30. The video signal recording means as set forth in claim 29, characterized in that said video signal decoding circuit is configured to extract a color subcarrier from color subcarrier bursts contained in said video signal in a fast locking mode.
